(19) United States
(12) Patent Application Publication
(10) Pub. No.: US 2003/0233880 A1
(43) Pub. Date: Dec. 25, 2003

(54) Ultrasonic tubular inspection apparatus having fluid interface and system and method incorporating same

(76) Inventors: David E. Siverling, Houston, TX (US); Bill McWhorter, Houston, TX (US)

Correspondence Address: Robert A. Van Someren, Fletcher, Yoder & Van Someren, P.O. Box 692289, Houston, TX, 77269-2289, US

(21) Appl. No.: 10/179,085

(22) Filed: Jun. 25, 2002

(51) Int. Cl. G01N 29/00

(52) U.S. Cl. 73/622

(57) ABSTRACT

The present technique provides a system and method for ultrasonically testing a tubular good through a fluid medium using a movable ultrasonic test assembly. The movable ultrasonic test assembly has a fluid chamber, which is open to an outer surface of the tubular good. Ultrasonic transducers are mountable in the movable ultrasonic test assembly, such that ultrasound waves are transmittable through fluid between the tubular and the ultrasonic transducers. The movable ultrasonic test assembly also may have a removable interface structure, which serves as a replaceable wear surface for movably supporting the ultrasonic test assembly on the outer surface of the tubular. A variety of positioning and control system also may be provided to perform an ultrasonic test of the tubular. For example, the positioning and control system may have drive assemblies for rotating the tubular and moving the ultrasonic test assembly along the tubular.

### FIELD OF THE INVENTION

The present technique relates generally to tubular inspection systems and, more particularly, to ultrasonic tubular inspection techniques for various tubular goods, such as oil country tubular goods (OCTG). The present technique provides a system and method for ultrasonically testing a tubular good through a fluid interface between the tubular good and ultrasonic transducers, which are movable along the tubular good.

### BACKGROUND OF THE INVENTION

Tubular goods are used in a variety of industrial applications, which may be particularly sensitive to internal defects. For example, a particular tubular good may have internal-external thickness variations, hairline fractures, seams, and various other longitudinally-oriented, transversely-oriented, and obliquely-oriented defects, which may be undetectable by alternative inspection techniques. These defects may arise during the initial manufacturing process, the subsequent processing or transportation, or they may occur as service-induced defects. In many industrial applications, the foregoing defects may lead to environmental damage, bodily injury, equipment damage and downtime, and loss of the associated product, such as hydrocarbon reserves.

Ultrasonic testing has been found to be particularly useful in detecting the foregoing defects, and in certain instances, ultrasonic testing provides the only detection mechanism for such defects. A variety of ultrasonic testing systems currently exist for testing tubular goods following manufacture and other processing stages. Each of these ultrasonic testing systems performs an ultrasonic examination in a helical scanning pattern about the surface of the tubular good. In fluid immersion systems, the tubular good is moved rotationally and longitudinally through a fluid bath, where a number of ultrasonic transducers reside. Although the fluid medium provides relatively low signal degradation from the ultrasonic transducers, these fluid immersion systems are cumbersome and difficult to use in pinpointing defects due to the size and momentum of the tubular goods. In rotating head systems, an assembly of ultrasonic transducers is rotated at high speeds about a tubular good, which is moved longitudinally through the rotating head assembly. Again, the size and momentum of the tubular good complicates the pinpointing of defects within the tubular good.

In other systems, the ultrasonic transducers are mounted in a contoured solid material, such as polystyrene or Lucite, which is moved along the rotating tubular good. In a different application, the ultrasonic transducers may be mounted in a rubber or polystyrene wheel. Both of these systems have a relatively lower sensitivity due to the use of an additional solid interface between the tubular good and the ultrasonic transducers. Moreover, the solids may have defects, such as scratches, which further reduce the ultrasonic sensitivity. These solid-interface systems also have other drawbacks, such as the inability to focus the ultrasonic beams, the relatively narrow inspection width of the rubber wheel system, and the consumability of the polystyrene shoe system.

Accordingly, a technique is needed for ultrasonically testing a tubular good using a movable ultrasonic test assembly having a fluid interface.

### SUMMARY OF THE INVENTION

The present technique provides a system and method for ultrasonically testing a tubular good through a fluid medium using a movable ultrasonic test assembly. The movable ultrasonic test assembly has a fluid chamber, which is open to an outer surface of the tubular good. Ultrasonic transducers are mountable in the movable ultrasonic test assembly, such that ultrasound waves are transmittable through fluid between the tubular and the ultrasonic transducers. The movable ultrasonic test assembly also may have a removable interface structure, which serves as a replaceable wear surface for movably supporting the ultrasonic test assembly on the outer surface of the tubular. A variety of positioning and control system also may be provided to perform an ultrasonic test of the tubular. For example, the positioning and control system may have drive assemblies for rotating the tubular and moving the ultrasonic test assembly along the tubular.

### BRIEF DESCRIPTION OF THE DRAWINGS

Exemplary embodiments will hereafter be described with reference to the accompanying drawings, wherein like reference numerals denote like elements, and:

FIG. 1 is a diagram of an exemplary ultrasonic test system of the present technique;

FIG. 2 is a perspective view of an exemplary ultrasonic test assembly of the system illustrated by FIG. 1;

FIG. 3 is a side view of an exemplary ultrasonic transducer unit for the ultrasonic test assembly illustrated by FIG. 2;

FIG. 4 is top view of the ultrasonic test assembly illustrating a plurality of differently oriented receptacles for the ultrasonic transducer unit illustrated by FIG. 3;

FIG. 5 is an end view of the ultrasonic test assembly top-mounted to a tubular illustrating transverse ultrasonic testing in opposite directions around the circumference of the tubular good;

FIG. 6 is a side view of the ultrasonic test assembly top-mounted to the tubular good illustrating longitudinal ultrasonic testing in opposite directions along the longitudinal axis of the tubular good; and

FIGS. 7 and 8 are side and bottom views of the ultrasonic test assembly illustrating a removable contact member disposed on an interface structure of the ultrasonic test assembly.

### DETAILED DESCRIPTION OF SPECIFIC EMBODIMENTS

As described in detail below, the present technique provides a system and method for ultrasonically testing a tubular good using a movable ultrasonic test assembly having a fluid interface between the tubular good and ultrasonic transducers. The fluid interface provides relatively strong signal transmission to the tubular good, while the movability of the ultrasonic test assembly avoids the cumbersome movement of large tubular goods. Accordingly, the movability of the ultrasonic test assembly allows rapid return of the ultrasonic transducers to a potential flaw, rather than requiring movement of the tubular good back to the flaw. The ultrasonic transducers may be disposed in a variety of normal-flaw-detection, transverse-flaw-detection, longitudinal-flaw-detection, and oblique-flaw-detection orientations in one or multiple directions, such as left/right and clockwise/counterclockwise directions. Moreover, the ultrasonic transducers may have curved lenses, such as spherical or cylindrical lenses, to focus the ultrasound (e.g., more collimated ultrasound) for better detection of defects and less signal degradation due to the curved surface of the tubular good. The movable ultrasonic test assembly of the present technique also has a removable contact member, which makes the assembly a non-consumable item that endures repeated use by replacing the removable contact member after a degree of wear.

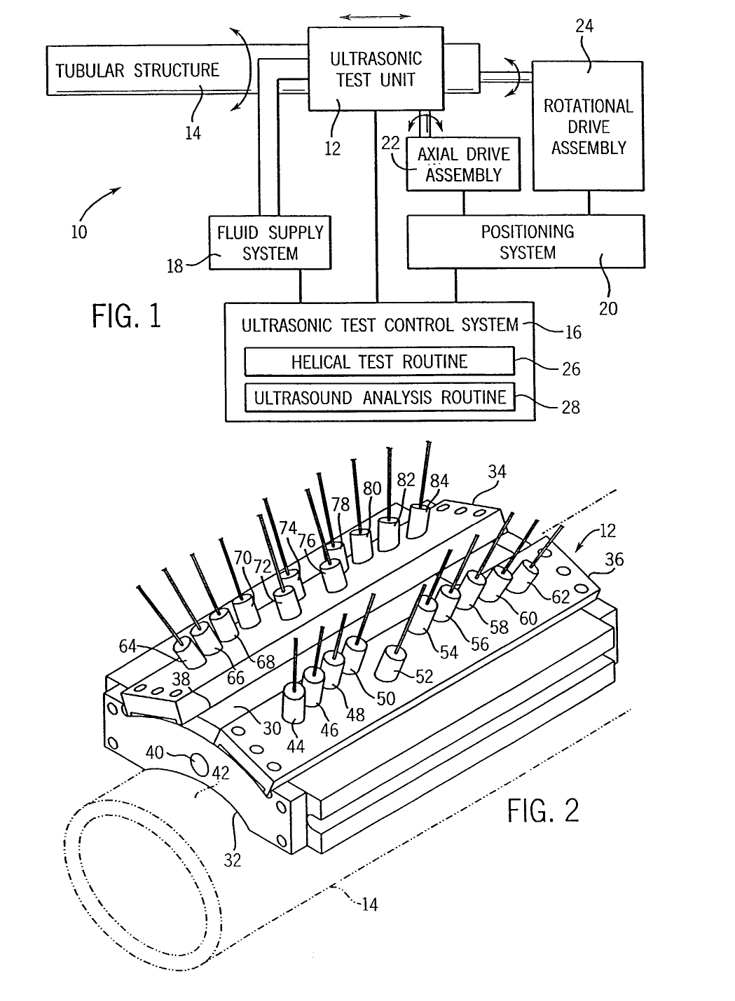

FIG. 1 is a diagram illustrating an exemplary ultrasonic test system 10 having an ultrasonic test assembly 12 of the present technique. As illustrated, the ultrasonic test assembly 12 is movably coupled to a tubular good 14, which may comprise oilfield casing, tubing, drill pipe, line pipe, or a variety of other oilfield or other industrial tubular goods. The ultrasonic test system 10 also comprises an ultrasonic test control system 16, which is communicatively coupled to a fluid supply system 18 and a positioning system 20. The fluid supply system 18 feeds a desired fluid, such as water, to the ultrasonic test assembly 12 to maintain a fluid interface between ultrasonic transducers and a top surface of the tubular good 14. The positioning system 20 is communicatively coupled to an axial drive assembly 22 for the ultrasonic test assembly 12, such that the ultrasonic test assembly 12 is longitudinally movable along the tubular good 14 during an ultrasonic test sequence. The positioning system 20 is also communicatively coupled to a rotational drive assembly 24, which rotates the tubular good 14 during the ultrasonic test sequence. Alternatively, the ultrasonic test assembly 12 may have a longitudinal and rotational drive assembly, which allows movement of the test unit 12 along and around tubular good 14 to minimize movement of the bulky tubular good 14 during ultrasonic testing. In operation, the ultrasonic test control system 16 may execute a helical test routine 26 to move the ultrasonic test assembly 12 and rotate the tubular good 14, such that ultrasonic transducers in the unit 12 traverse the tubular good 14 in a helical test pattern. The ultrasonic test control system 16 also may comprise an ultrasound analysis routine 28 for evaluating ultrasound reflections and identifying defects in the tubular good 14. The ultrasonic test system 10 also may comprise a variety of other hardware and software within the scope of the present technique.

FIG. 2 is a perspective view of an exemplary embodiment of the ultrasonic test assembly 12 top-mounted to the tubular good 14. As illustrated, the ultrasonic test assembly 12 has a fluid chamber 30 disposed between a mount interface 32 and a pair of transducer mount panels 34 and 36. The illustrated fluid chamber 30 is open at a top opening 38 between the transducer mount panels 34 and 36 and is fillable via a fluid inlet 40. However, the fluid chamber 30 may comprise any suitable fluid retention structure and filling mechanism. For example, the fluid chamber 30 may comprise a pressurized fluid chamber to allow positioning of the ultrasonic test assembly 12 at any position around the tubular good 14. The mount interface 32 is substantially sealable against a top surface 42 of the tubular good 14, such that fluid is substantially retained within the fluid chamber 30 in fluid contact with the top surface 42 and ultrasonic transducers disposed within the transducer mount panels 34 and 36. As illustrated, the transducer mount panels 34 and 36 have ultrasonic transducer units 44-84 disposed in transducer mount receptacles, which may be in transverse, longitudinal, perpendicular, or oblique testing orientations in one or more directions relative to the tubular good 14.

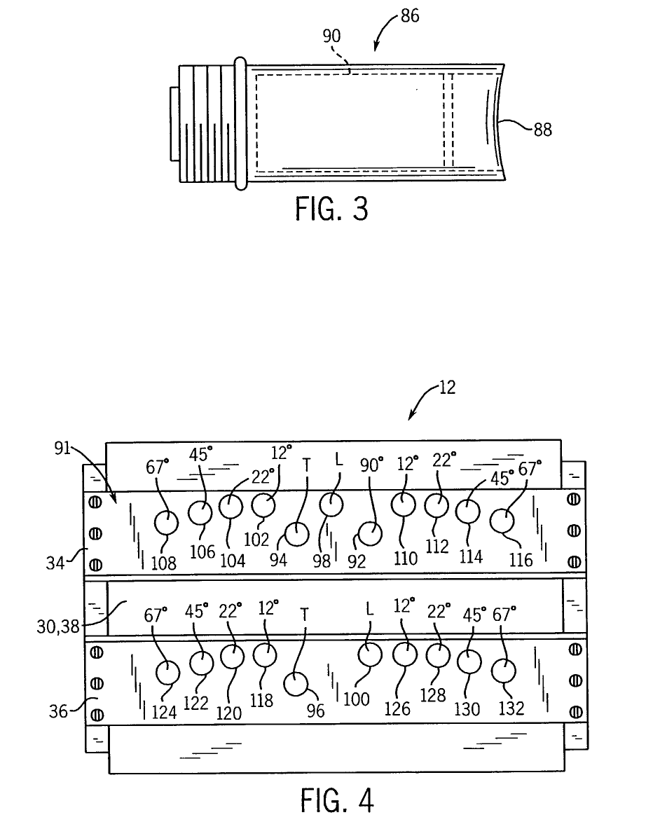

Each of the ultrasonic transducer units 44-84 also may comprise a variety of ultrasonic transducer elements, lenses, and circuitry to transmit a desired ultrasonic beam and interpret an ultrasonic echo reflected back from a defect. For example, the ultrasonic transducer units 44-84 may comprise a piezoelectric element and a lens, such as a flat, cylindrical, or spherical lens. The curved lenses accommodate the curved surface of the tubular good 14 to minimize the loss of incident sound energy on the curved surface of the tubular good 14. In operation, the cylindrical lens focuses sound energy to a line and the spherical lens focuses sound energy to a spot. FIG. 3 is a side view of an exemplary line-focused ultrasonic transducer unit 86, which has a cylindrical lens 88 and an internal piezoelectric element 90 for transmitting and receiving ultrasounds. Accordingly, the ultrasonic test assembly 12 of the present technique may use spot-focused or line-focused ultrasonic transducer units to provide more accurate detection of internal defects.

The ultrasonic test assembly 12 also may position the ultrasonic transducer units 44-84 in a variety of detection orientations and directions. FIG. 4 is a top view of the ultrasonic test assembly 12 having a plurality of transducer mount receptacles 91 disposed in the transducer mount panels 34 and 36. As illustrated, the transducer mount receptacles 91 are disposed in perpendicular angles, longitudinally-oriented angles, transversely-oriented angles, and obliquely-oriented angles to detect perpendicular defects, transverse defects, longitudinal defects, and oblique defects, respectively. The foregoing defects are detected by positioning the ultrasonic transducer units 44-84 at an incident angle in the fluid within the fluid chamber 30, such that the ultrasonic transducer units 44-84 generate a shear wave mode in the tubular good 14 at, for example, an angle of approximately 45 degrees. For transverse flaw detection, an exemplary incident angle is approximately 17 degrees. The incident angles for longitudinal and oblique flaw detection varies depending on the curve of the tubular good 14. The transducer mount receptacles 91 are also staggered to provide for a complete coverage of the tubular good 14 during the ultrasonic inspection. In this exemplary embodiment, the transducer mount receptacles 91 may be configured for a 30 percent overlap of the mounted ultrasonic transducer units 44-84.

In the illustrated embodiment of FIG. 4, the transducer mount receptacles 91 comprise a normal-detection receptacle 92, transverse-detection receptacles 94 and 96, and longitudinal-detection receptacles 98 and 100. The normal-detection receptacle 92 is oriented normal to the curved surface of the tubular good 14 to direct sound waves perpendicularly into the tubular good 14. These normally-directed sound waves detect wall thickness variations in the tubular good 14. The transverse-detection receptacles 94 and 96 are angled along the axis of the tubular good 14 to direct sound waves from a mounted ultrasonic transducer unit longitudinally along the tubular good 14. These longitudinally directed sound waves detect transverse flaws within the tubular good 14. As noted above, the transverse-detection receptacles 94 and 96 are disposed at an incident angle of 17 degrees. The transverse-detection receptacles 94 and 96 also may be disposed in different directions, such as leftward and rightward directions, relative to the tubular good 14.

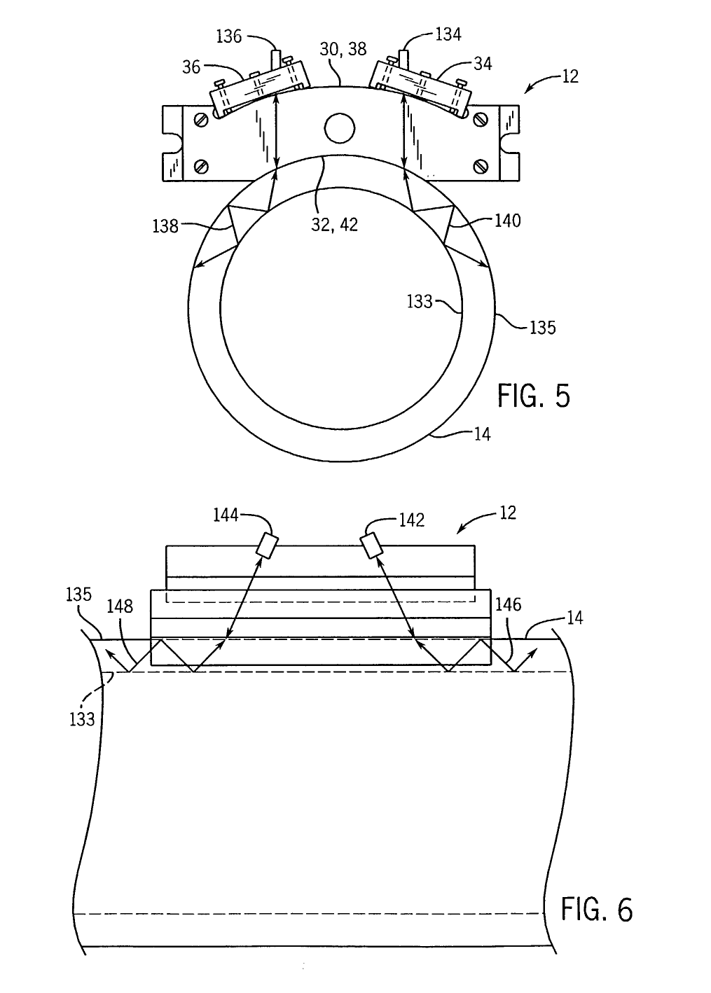

The longitudinal-detection receptacles 98 and 100 are angled circumferentially about the tubular good 14 to direct sound waves from a mounted ultrasonic transducer unit around the circumference of the tubular good 14. These circumferentially or transversely directed sound waves detect longitudinal flaws within the tubular good 14. Again, the longitudinal-detection receptacles 98 and 100 may be disposed in different directions, such as clockwise and counterclockwise directions, relative to the tubular good 14. For example, the off-center positioning of the transducer mount panels 34 and 36 may facilitate multi-directional ultrasonic testing in the various testing orientations. The foregoing multi-directional positioning is discussed in further detail below with reference to FIGS. 5 and 6.

If oblique-flaw detection is desired, then a variety of oblique-detection receptacles may be disposed within the ultrasonic test assembly 12. The transducer mount receptacles 91 illustrated by FIG. 4 comprise oblique-detection receptacles 102-116 and 118-132, which are disposed in transducer mount panels 34 and 36, respectively. The oblique-detection receptacles 102, 104, 106, and 108 are obliquely-oriented for detection of oblique-flaws at exemplary angles of 12, 22.5, 45, and 67 degrees in a leftward clockwise direction relative to the tubular good 14. In this same example, the oblique-detection receptacles 110, 112, 114, and 116 are obliquely-oriented for detection of oblique-flaws at exemplary angles of 12, 22.5, 45, and 67 degrees in a rightward clockwise direction relative to the tubular good 14. The oblique-detection receptacles 118, 120, 122, and 124 are obliquely-oriented for detection of oblique-flaws at exemplary angles of 12, 22.5, 45, and 67 degrees in a leftward counterclockwise direction relative to the tubular good 14. The oblique-detection receptacles 126, 128, 130, and 132 are obliquely-oriented for detection of oblique-flaws at exemplary angles of 12, 22.5, 45, and 67 degrees in a rightward counterclockwise direction relative to the tubular good 14. Again, an incident angle is selected to generate an exemplary 45 degree shear wave in the tubular good 14 for each of the foregoing oblique-detection receptacles.

FIGS. 5 and 6 illustrate sound wave transmission through the tubular good 14 between inner and outer surfaces 133 and 135 in multiple directions oriented to detect transverse and longitudinal flaws, respectively. FIG. 5 is an end view of the ultrasonic test assembly 12 top-mounted to the tubular good 14 illustrating the operation of transversely-oriented ultrasonic transducer units 134 and 136, which are disposed in the transducer mount panels 34 and 36, respectively. As illustrated, the transversely-oriented ultrasonic transducer units 134 and 136 transmit ultrasounds 138 and 140 through fluid in the fluid chamber 30 at the appropriate incident angle, into the tubular good 14 at an angle of approximately 45 degrees, and around the circumference of the tubular good 14 in clockwise and counterclockwise directions, respectively. Again, the ultrasounds 138 and 140 may be spot-focused or line-focused by using spherical or cylindrical lenses, respectively. Moreover, the direct fluid interface between the ultrasonic transducer units 134 and 136 and the tubular good 14 provides greater sensitivity and less signal degradation than a solid interface. If a longitudinal flaw exists in the tubular good 14, then the respective ultrasound 138 or 140 reflects back to the respective ultrasonic transducer unit 134 or 136. The respective ultrasonic transducer unit 134 or 136 then converts the reflected sound (or echo) into electrical energy, which is used to identify the longitudinal flaw to the ultrasonic test control system 16 illustrated by FIG. 2.

FIG. 6 is a side view of the ultrasonic test assembly 12 top-mounted to the tubular good 14 illustrating the operation of longitudinally-oriented ultrasonic transducer units 142 and 144, which are disposed in the transducer mount panels 34 and 36. As illustrated, the longitudinally-oriented ultrasonic transducer units 142 and 144 transmit ultrasounds 146 and 148 through fluid in the fluid chamber 30 at the appropriate incident angle, into the tubular good 14 at an angle of 45 degrees, and longitudinally along the tubular good 14 in rightward and leftward directions, respectively. As discussed above, the present technique improves the sensitivity and reduces signal degradation of the ultrasonic transducer units 142 and 144 by using a direct fluid interface and curved lenses for the transmission of ultrasounds 138 and 140. If a transverse flaw exists in the tubular good 14 in either the leftward or rightward direction, then the respective ultrasound 146 or 148 reflects back to the respective ultrasonic transducer unit 142 or 144. The respective ultrasonic transducer unit 142 or 144 then converts the reflected sound (or echo) into electrical energy, which is used to identify the transverse flaw to the ultrasonic test control system 16 illustrated by FIG. 2.

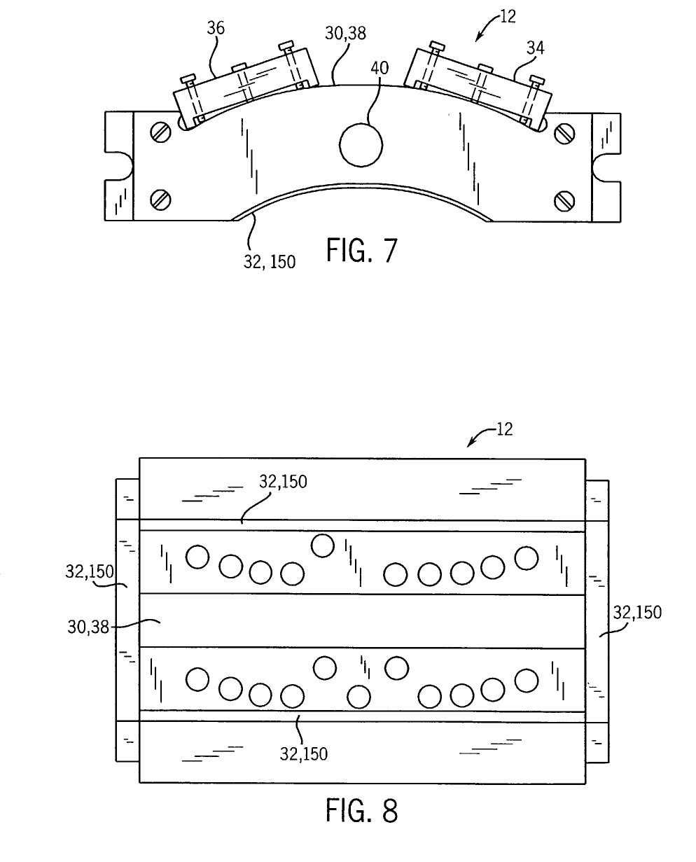

In addition to the fluid interface and curved lenses of the ultrasonic test assembly 12, the present technique may have a removable seal or gasket for interfacing with the top surface 42 of the tubular good 14. FIGS. 7 and 8 are end and bottom views of the ultrasonic test assembly 12 illustrating an exemplary removable contact member 150, which may comprise any suitable material for movably contacting the tubular good 14. For example, the removable contact member 150 may comprise a low friction or self-lubricating material, such as UHMW, Teflon, or any other suitable long-chain polymer. In operation, the removable contact member 150 slides along the surface of the tubular good 14 and substantially retains fluid within the fluid chamber 30 of the ultrasonic test assembly 12. The removable contact member 150 may survive a relatively large number of ultrasonic tests, such as 200 tests, depending on the surface conditions of the tubular good 14, the thickness and substance of the removable contact member 150, and various other testing conditions. At any time, the removable contact member 150 may be replaced with another removable contact member 150 to refurbish the ultrasonic test assembly 12 or to accommodate a different ultrasonic test, a different tubular good, or any other testing conditions. The removable contact member 150 also allows the ultrasonic test assembly 12 to be formed from any desired material, because the removable contact member 150 interfaces and wears along the tubular good 14 rather than the ultrasonic test assembly 12. For example, the ultrasonic test assembly 12 may comprise aluminum, nylon, nylatride, Delrin, or any other rigid material.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system for ultrasonically testing a tubular, comprising:
a top-mountable ultrasonic test assembly, comprising:
an ultrasonic transducer mount panel; and
a fluid chamber formed between the ultrasonic transducer mount panel and a mount interface, which is movably positional along a top surface of the tubular.

2. The system of claim 1, wherein the ultrasonic transducer mount panel comprises a plurality of ultrasonic transducers.

3. The system of claim 2, wherein the plurality of ultrasonic transducers are disposed in a plurality of ultrasonic testing orientations.

4. The system of claim 1, wherein the ultrasonic transducer mount panel comprises an ultrasonic transducer having a curved lens.

5. The system of claim 1, wherein the ultrasonic transducer mount panel comprises an ultrasonic transducer having a piezoelectric element.

6. The system of claim 1, wherein the ultrasonic transducer mount panel comprises a plurality of transducer mount receptacles oriented in different testing orientations.

7. The system of claim 6, wherein the plurality of transducer mount receptacles comprise a transducer receptacle oriented in a longitudinal testing orientation.

8. The system of claim 6, wherein the plurality of transducer mount receptacles comprise a transducer receptacle oriented in a transverse testing orientation.

9. The system of claim 6, wherein the plurality of transducer mount receptacles comprise a transducer receptacle oriented in an oblique testing orientation.

10. The system of claim 1, wherein the ultrasonic transducer mount panel comprises a pair of off-center panels having transducer mount receptacles for multi-orientational testing in multiple directions relative to the tubular.

11. The system of claim 1, wherein the fluid chamber is open to the top surface in a desired ultrasonic testing region.

12. The system of claim 1, wherein the mount interface comprises a removable contact member.

13. The system of claim 12, wherein the removable contact member is substantially sealable against the top surface of the tubular.

14. The system of claim 12, wherein the removable contact member comprises a relatively low friction material.

15. The system of claim 12, wherein the removable contact member comprises a self-lubricating polymer.

16. The system of claim 1, comprising an ultrasonic test positioning system for relative movement between the tubular and the top-mountable ultrasonic test assembly.

17. The system of claim 16, wherein the ultrasonic test positioning system comprises a longitudinal drive assembly coupled to the top-mountable ultrasonic test assembly.

18. The system of claim 16, wherein the ultrasonic test positioning system comprises a rotational drive assembly coupleable to the tubular.

19. The system of claim 16, wherein the ultrasonic test positioning system comprises a helical test pattern routine.

20. A system for ultrasonically testing a tubular, comprising:
a top-mountable ultrasonic test assembly, comprising:
an ultrasonic transducer mount having receptacles for a plurality of ultrasonic transducers in different testing orientations; and
a fluid chamber formed between the ultrasonic transducer mount and a mount interface, which is internally open to and movably positionable along a top surface of the tubular; and
a positioning and control system coupled to the top-mountable ultrasonic test assembly.

21. The system of claim 20, comprising an ultrasonic transducer in each of the receptacles.

22. The system of claim 20, wherein at least one of the receptacles is oriented in a longitudinal testing orientation.

23. The system of claim 20, wherein at least one of the receptacles is oriented in a transverse testing orientation.

24. The system of claim 20, wherein at least one of the receptacles is oriented in an oblique testing orientation.

25. The system of claim 20, wherein the ultrasonic transducer mount comprises multiple panels having the receptacles positioned for multi-directional testing relative to the tubular.

26. The system of claim 20, wherein the mount interface comprises a replaceable bearing contact layer.

27. The system of claim 26, wherein the replaceable bearing contact layer comprises a relatively low friction material.

28. A system for ultrasonically testing a tubular, comprising:
movable ultrasonic testing means for ultrasonically testing the tubular through a fluid medium; and
multi-orientational ultrasonic transducer positioning means for facilitating ultrasonic testing in different orientations relative to the tubular.

29. The system of claim 28, comprising removable contact means for interfacing an outer surface of the tubular with the ultrasonic testing means.

30. The system of claim 28, comprising control means coupled to the movable ultrasonic testing means.

31. A method for ultrasonically testing a tubular, comprising the acts of:
providing a movable ultrasonic test assembly for the tubular;
forming a fluid testing interface between the tubular and ultrasonic transducers disposed in the movable ultrasonic test assembly; and
controlling an ultrasonic test pattern of movement between the ultrasonic test assembly and the tubular.

32. The method of claim 31, wherein the act of providing the movable ultrasonic test assembly comprises the act of supporting the ultrasonic transducers in different testing orientations.

33. The method of claim 32, wherein the act of supporting the ultrasonic transducers comprises the act of positioning at least one ultrasonic transducer in a transverse testing orientation.

34. The method of claim 32, wherein the act of supporting the ultrasonic transducers comprises the act of positioning at least one ultrasonic transducer in a longitudinal testing orientation.

35. The method of claim 32, wherein the act of supporting the ultrasonic transducers comprises the act of positioning at least one ultrasonic transducer in an oblique testing orientation.

36. The method of claim 31, wherein the act of providing the movable ultrasonic test assembly comprises the act of movably disposing the movable ultrasonic test assembly on a top surface of the tubular.

37. The method of claim 31, wherein the act of controlling the ultrasonic test pattern of movement comprises the act of moving the movable ultrasonic test assembly along the tubular.

38. The method of claim 31, wherein the act of controlling the ultrasonic test pattern of movement comprises the act of rotating the tubular.

39. The method of claim 31, comprising the act of coupling a removable contact structure to a tubular-interface-side of the movable ultrasonic test assembly.

40. The method of claim 39, comprising the act of replacing the removable contact structure after being worn by movement between the movable ultrasonic test assembly and the tubular.
